(19) United States
(12) Patent Application Publication
(10) Pub. No.: US 2006/0116986 A1
(43) Pub. Date: Jun. 1, 2006

(54) Formulating and refining queries on structured data

(75) Inventor: Nicholas Radcliffe, Edinburgh (GB)

Correspondence Address: BROMBERG & SUNSTEIN LLP, 125 SUMMER STREET, BOSTON, MA, 02110-1618, US

(73) Assignee: Quadstone Limited

(21) Appl. No.: 11/009,418

(22) Filed: Dec. 10, 2004

(30) Foreign Application Priority Data
Nov. 12, 2004 (GB) 0425087.4

(51) Int. Cl. G06F 17/30

(52) U.S. Cl. 707/3

(57) ABSTRACT

A system is described that can aid the querying of structured data stored in a computer system, with particular emphasis on a class of complex queries representing cross tabulations and queries requiring the building of models for their resolution. In the first step the system reads the description of query languages supported by one or more information storage systems; it goes on to read the data dictionaries or other metadata that define the data stored within such systems and finally it optionally reads translation lists concerning the data. The user is then requested to enter a set of keywords describing the search that is needed. The information gathered in the first step is searched and the system returns the most relevant queries as a set of links sorted by relevance. The responses include readable definitions of the queries and more formal query specifications. The system can also display a more accurate representation of the query using associated keywords, thus providing relevance feedback. When a link is selected the underlying query may be run and the results from the data returned. The mechanism is also applicable to formulating complex queries against data models.

### TECHNICAL FIELD OF THE INVENTION

The present invention relates to a method and apparatus for formulating and refining complex queries on structured data without requiring the user to present those queries in a formal query language. More specifically, the invention relates to a method and an apparatus, which allow a user to access useful information stored in a database or in a similar format, without needing to know either details of the query language used to access the database or details such as the names of the categories in which data has been stored.

### DESCRIPTION OF RELATED ART

There have been many attempts to make it easy for unskilled users to obtain information from a complex database. Normally a query will be written in a formal query language such as SQL, which has a strict syntax and which is hard to write for someone unskilled. Early attempts included the use of “wizards” used today in products such as Microsoft's® Access®, where questions are asked, and the user is prompted to make choices. The relevant query is then constructed automatically on the basis of these responses.

There have been many attempts to create graphical query languages. The document “XML-GL: a Graphical Language for Querying and Restructuring XML Documents”, Ceri et al, Eighth World Wide Web Conference, 1999 describes a graphical language for querying XML databases. U.S. Pat. No. 6,768,997 (Shirmer et al) discloses a query mechanism using movable tiles as a way of defining a Boolean query.

There have also been many attempts to allow databases to be queried using “natural language” such as simple English sentences. The premise here is that it is easier for a computer system to understand an English sentence, in the limited context of the alternatives offered by the possible range of queries, than where that sentence could in principle be about any subject. U.S. Pat. No. 5,454,106 (Burns and Malhotra) describes such a mechanism, and suggests matching words on the names of databases, fields, joins and views and then either presenting the result of a database query if the words can be uniquely matched with database names, or allowing the user to browse the schema of the database to determine a suitable query if there is an ambiguous match.

U.S. Pat. No. 6,701,294 (Ball et al) discloses another natural language interface mechanism. U.S. Pat. No. 6,778,951 (Contractor) discloses a further natural language interface to an information retrieval system.

There have also been methods disclosed where only standardised, and hence optimised, queries can be evaluated. The document “Improving Database Performance Through Query Standardization”, Makkamala et al, IEEE Proceedings, 1989 Southeastern, pp. 1321-1325 published a scheme to store standardised queries within a strategy database. U.S. Pat. No. 6,671,681 (Emens et al) discloses a mechanism for using previously executed queries to aid inexperienced users.

U.S. Pat. No. 6,801,904 (Chaudhuri) discloses a way of presenting a search for keywords through several relational databases, as if the results had come from an internet search engine, thus providing a familiar interface for unsophisticated users. More specifically, this document describes a system, in which a database is preprocessed, to form an index of the data records. When the user enters particular keywords, the index is accessed to identify regions of the database that contain data records relating to these keywords. A query is then constructed, corresponding to the entered keywords, and the query is executed on the identified regions of the database to retrieve specific data records matching the keywords. However, this still requires the user to enter keywords which are actually used in the data records, in order to obtain a useful output, and does not permit more general searching of the database.

One of the mechanisms most commonly used by experienced and inexperienced computer users alike is the internet search engine, the most well-known of which at this time is the Google® search engine. By using internet search engines, users have become familiar with the mechanism whereby a few keywords are typed in and the search engine displays the Uniform Resource Locators (URLs) of the most relevant web pages, displayed in relevance order along with a brief precis of what the page is about.

### SUMMARY OF THE INVENTION

The present invention relates to a method and a system, which allow the inexperienced database searcher to access a database, by means of an interface, which is similar to that presented by internet search engines, in that it accepts a set of keywords to be searched, and then presents the user with a set of possible results.

However, instead of searching the pages of the World Wide Web, as in an internet search engine, or searching the data records contained in the underlying database, as proposed in U.S. Pat. No. 6,801,904, the system instead searches the set of all possible queries that could be executed on the aforesaid database, optionally including queries that require the building of a model for their resolution. These possible queries are then presented to the user in an ordered list, with the first query being the one judged to be most likely to have been the query which the user would have intended. Explanatory text associated with each query describes the search in English. The possible queries are presented in the form of clickable links, and, when a link is clicked, the query is executed against the aforesaid database and the results returned.

This allows the user to perform queries in the form of analytical questions concerning large bodies of data, although the invention is not limited to such cases. Examples of such analytical questions are cross tabulations showing counts broken down by one or more fields, and other statistics broken down by other fields, and often including restrictions to subsets of the data of interest.

In a first aspect, the invention is directed to a method for providing a list of possible queries to be applied to one or more data storage systems, comprising:

receiving one or more keywords based on a user input;

comparing the received keywords with information based on metadata describing the data stored in the systems, in order to obtain matches between said received keywords and said information; and

based on said matches, generating a list of one or more possible queries, which could be applied to said one or more data storage systems.

According to another embodiment of the invention, there is provided a computer system, adapted to operate in accordance with the method of the first embodiment.

According to a further embodiment of the invention, there is provided a computer program product, containing computer readable code adapted to cause operation in accordance with the method of the first embodiment.

### BRIEF DESCRIPTION OF THE DRAWINGS

FIG. 1 is a schematic representation of a computer system on which the method according to the invention can be performed.

FIG. 2 is a flowchart, illustrating the method according to the invention.

FIGS. 3, 4, 5 and 6 show examples of web pages generated and displayed to a user during operation of the invention.

### DETAILED DESCRIPTION OF THE PREFERRED EMBODIMENTS

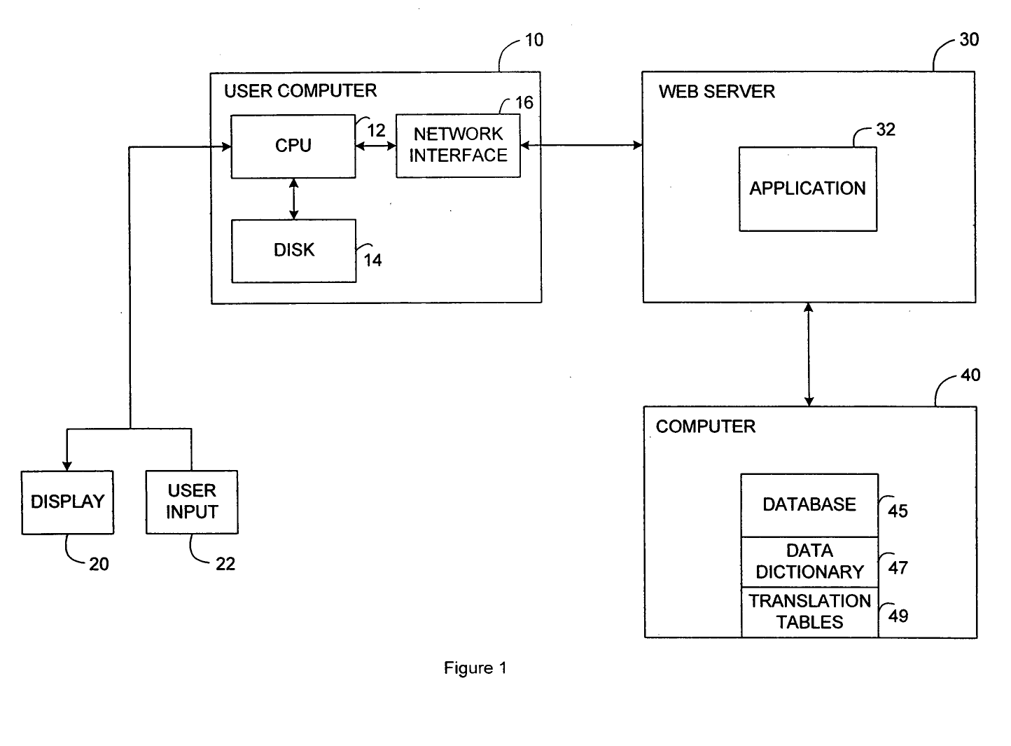

FIG. 1 is a block schematic diagram of a computer system, in accordance with the present invention. Specifically, a user computer 10 has one or more central processors (CPU) 12, one or more disks 14, and a network interface 16. The user computer 10 may include an integral user interface, but, in this illustrated embodiment, it is connected to a display 20, for presenting information to a user, and to a user input device 22, which in this embodiment takes the form of a keyboard, although it will be appreciated that other user interfaces are possible. It will be appreciated by the person skilled in the art that the user computer 10, which is generally conventional, has various other features, which will be well known to the person skilled in the art. However, these features will not be described, except in so far as they are relevant to the operation of the present invention.

The user computer 10 has a connection via its network interface 16 to a first web server computer 30. As is well known, an application 32 can run on the web server 30 that can present a user with data in the form of web pages, and can request inputs from the user via such web pages, and the user of the computer 10 can access these web pages, and download the information generated by the application 32 for viewing on the display 20.

The user computer 10 can also connect through the web server 30 to a further computer 40 that contains a database 45. As is well known in the art, such a database can return information stored within it by means of executing a number of queries using a formal language such as SQL. The database 45 contains a number of tables containing data. Some of these tables represent data that are commonly called a data dictionary 47. The data dictionary 47 contains the names of all the tables in the database, and the columns within each of the tables, and also includes descriptive text about each of these. Thus, the data dictionary 47 contains metadata, that is, data about the data which is stored in the database 45. The database 45 also contains translation tables 49, which for example contains lists of synonyms for words appearing in the data dictionary 47.

The application 32 running on the first web server computer 30 aids searching of the database 45 via a web interface, as will be described in more detail below. It should also be noted that this illustrated arrangement is only one way in which the invention can be implemented, and is perhaps appropriate to an environment in which multiple user computers within an organization are connected to the web server 30 in order to be able to access the internet, while the database 45 is stored on a separate computer 40, in order that sufficient memory and other resources are available. However, the invention is also applicable in other situations, for example where the database is stored on a personal computer, which is also running a web browser program and the application for aiding searching of the database.

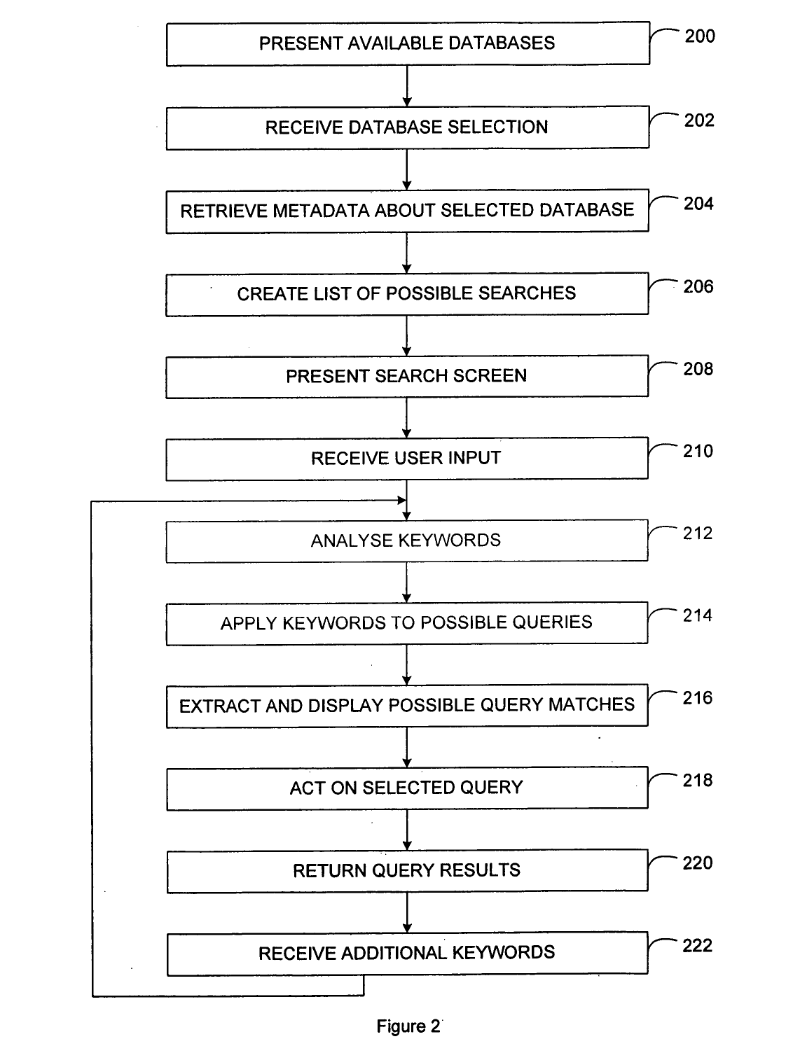

FIG. 2 is a flow chart, illustrating the operation of a preferred embodiment of the invention. Specifically, in step 200, the user is presented by the application 32 with a web page, which contains a list of available databases, and asks the user to select one or more of those databases, for example by clicking on the one or more databases in the list presented. The available databases are those, in connection with which the appropriate preprocessing has been performed, as will be described in more detail below.

In step 202, the application 32 receives the user's selection of one or more of the available databases. In the example given below, the selected database contains the call records of a mobile telephone operator. Thus, the database contains data about the calls made by each customer, but also contains other data about the customers, for example such as their addresses, incomes, genders, and ages, and data about their telephone service, for example such as the date on which their service contract started, how the customer was recruited, whether the customer is a business user, which type of phone they have, and what their credit limit is.

In response to this selection, in step 204 the application 32 contacts the database server 40 and selects from the database 45 the data dictionary 47 and translation tables 49. In other embodiments of the invention, the translation tables may be stored in the computer on which the application 32 is running, or may be created only from the data dictionary 47 only in response to the selection by the user of the specific database.

Then, in step 206, the application 32 determines from the data dictionary 47 a schema, which is representative of some or all of the possible queries that could be executed on the database 45. In other embodiments of the invention, this list could be created as soon as the database is made available for selection by the user, or it could be created when the database is first selected by the user and then made available whenever the database is subsequently selected by the user.

It will be appreciated that the set of such queries could in fact be infinite, so the application 32 actually constructs a model that represents the space of all possible queries.

For example, one class of queries consists of one or more aggregations to be calculated over a segmentation of a database. In the case of the database containing the call records and customer information of a mobile telephone operator, as mentioned above, an example of such a query would involve calculating the average customer spend during some period, broken down as a function of the customers' age and income (in bands).

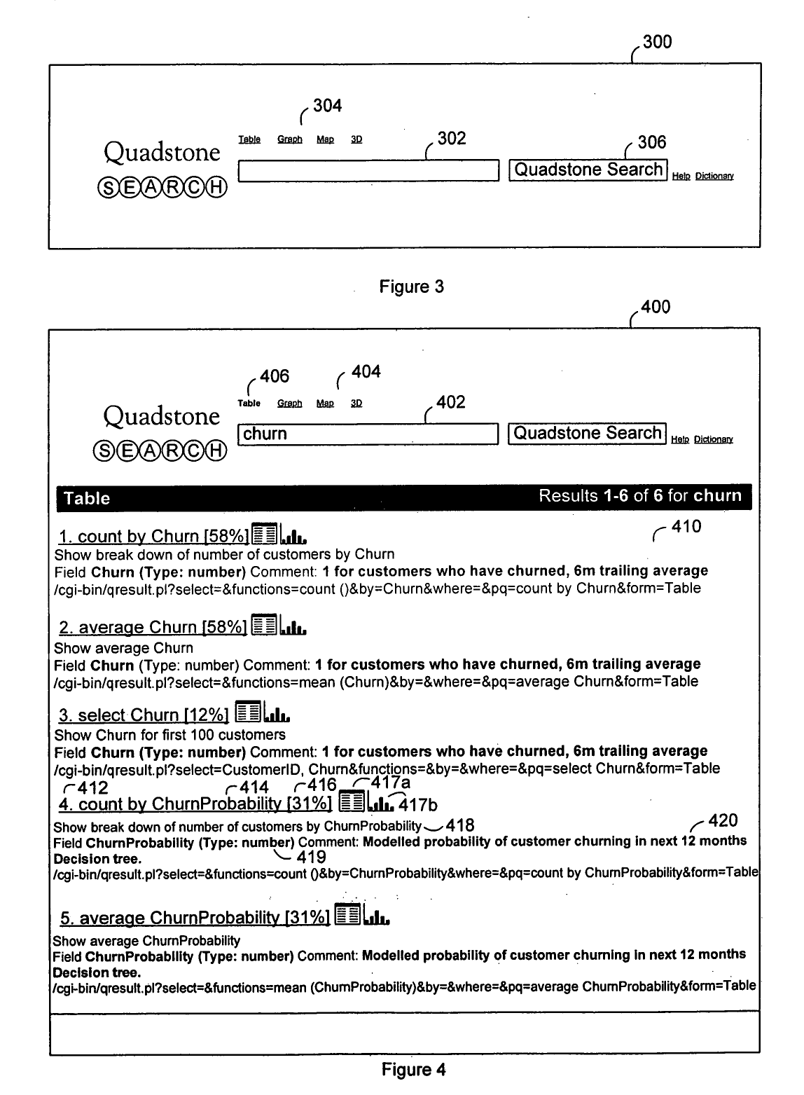

In step 208 the application 32 presents the user with a web page. FIG. 3 shows the form of the web page 300 presented to the user. In this illustrated example, the web page 300 includes a text box 302, into which the user can type one or more keywords representing potential queries.

The web page 300 also presents various options 304, “Table”, “Graph”, “Map” and “3D”, representing ways in which the user can choose to have the results presented. The web page 300 also includes a box 306, labelled “Search”, which the user can click to initiate the next step in the process.

It will be noted that the web page 300 resembles the web pages which are presented to users by internet search engines, so that the application 32 achieves ready acceptability by users.

In step 210 of the process, the application 32 receives the user input. That is, the application 32 receives the text entered into the text box 302, when the box 306 is clicked. The text can include one or more words or numbers or other character strings, and can also include punctuation marks and mathematical symbols. The text input by the user is referred to herein as the “keyword” or “keywords”.

In step 212, the application 32 then analyses these keywords using techniques well known to those skilled in the art of information retrieval, such as word stemming, stop word removal, relevance weighting and application of synonyms. In this respect, the application 32 uses the translation tables 49, which include synonyms derived from comments held within the data dictionary 47.

For example, if the user enters the text “how many men have earnings >£20,000”, the word “how many” can be converted to “count”, and the word “men” can be converted to “Male”. The next step would be to identify that “earnings” is the name of a column in a particular table within the database 45. Finally, if a comment field for a column called Gender contains the values 0, corresponding to Male, and 1, corresponding to Female, the column Gender would be identified, and the constraint that its value equals 0 would be applied.

In step 214, the keywords resulting from this analysis process are then applied to the model that generates the set of all possible queries.

In step 216, potential query matches are then extracted, and displayed to the user. As mentioned above, one class of queries consists of one or more aggregations to be calculated over a segmentation of a database. A template for this class of query could be represented as:
[function(field)|zeroargfunction( )]+by [field [breakdown spec]]+
where the “+” symbol indicates “one or more occurrences of”, and so this could be read as “one or more functions, each possibly taking a field as an argument, followed by the special keyword ‘by’ followed by one or more fields, each with an optional specification of how the field should be broken down”. An example of an expression that matched this template would be:

mean Spend by Income Gender

A string of received keywords might be analysed as a possible match against this template by trying to identify words in the string as potential function names (like “mean”) special keywords (like “by”), potential field names (like “income”, “sex”) and potential breakdown specifications (such as “deciles”). This matching process might include translations from the translation tables 49 (e.g. “average” as a synonym for “mean”), allowed omissions (the special keyword “by”, the name of the aggregation), matching against field metadata from the data dictionary 47 (e.g. a comment on the income field might include the phrase “annual salary”), and various other fuzzy matching mechanisms such as rearrangement, stemming, fuzzy keyword matching and so forth. This might allow an input such as:

Spend Income Sex

to result in a match against the template being offered with the instantiation given above (mean Spend by Income Gender).

FIG. 4 shows the form of a web page 400, which can be presented to the user to display these results. As in the web page 300 shown in FIG. 3, the web page 400 includes a text box 402, which, in this case, shows the user's previous input, namely the keyword “churn”, churn being the word used in the industry to indicate the probability that a customer will terminate his contract with a supplier.

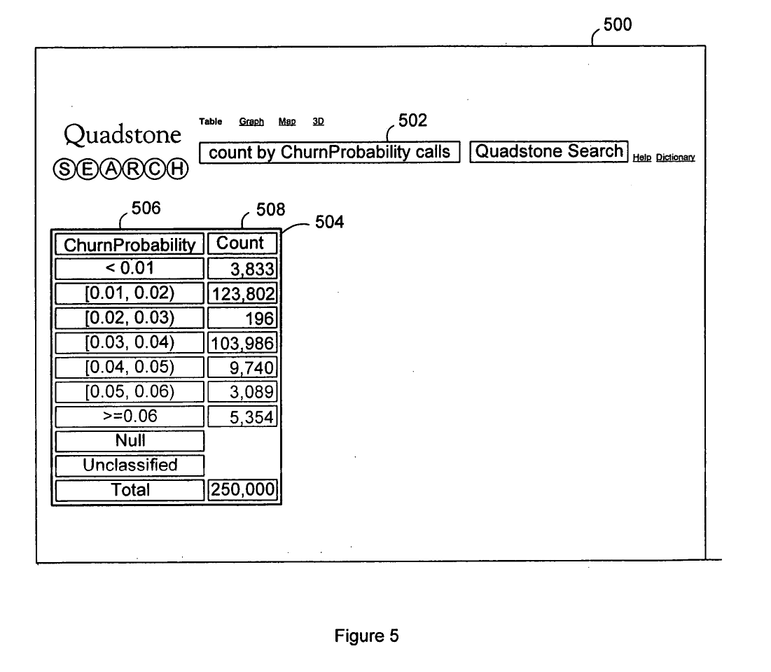

The web page 400 also indicates the various options 404, “Table”, “Graph”, “Map” and “3D”, with the “Table” option 406 being shown in a particular colour or typeface, to indicate that this has been chosen by the user. The web page 400 also indicates at 408 that 6 results were found, and that all 6 are presented on this screen (although only 5 are visible in FIG. 5).

Finally, the web page 400 displays to the user a list 410 of some or all of the possible queries that could be applied to the database that matched the input keyword or keywords. The list 410 is sorted by relevance, with the most relevant shown as item 1, and so on. In general, any input string will potentially match against more than one of the possible templates described above, and in the case of each template match, the match may occur with different instantiations. The system therefore provides some kind of “relevance” measure to allow potential queries to be ranked for the user. As an illustrative example, a scheme for determining “relevance” awards credit for elements that match precisely with an item of metadata from the data dictionary 47, lesser credit for elements in the input string that match approximately with an item of metadata from the data dictionary 47, and penalties for terms that cannot be matched, and for rearrangements that have to be performed. These credits and penalties (negative credits) can be summed to provide a relevance score, which may then be normalized to a percentage scale.

Each of the possible queries is then presented as an item in the list 410, shown in the same way. In this case, item “4” in the list is described in more detail. Thus, the presentation of the item shows first its “relevance” ranking 412, i.e. “4” in this case, and then a hyperlink 414, followed by its relevance score 416, in this case 31%, and icons representing different possible display formats for the query. Thus, in the case of item “4” in the list, a first icon 417a indicates that the results can be presented as a table, while a second icon 417b indicates that the results can alternatively be presented as a bar graph.

The application 32 is able to create an English language description of each of the possible queries from the formal syntax of the query language and this English language description 418 is presented to the user, along with the more formal version, which is presented as the hyperlink 414. Thus, as well as the more formal version (namely “count by ChurnProbability”), the user is also presented with the more readily understandable English language description 418 (namely “Show breakdown of number of customers by ChurnProbability”), which helps the user to select the correct query to be run.

The user is also presented with relevant metadata 419 and a comment 420 about the query.

The underlying hyperlink 414 associated with each list entry is a link to the database server 40 and the formal query that can be understood by the database 45. If the user clicks on the hyperlink 414 for a selected query in the list, then, at step 218 in the procedure of FIG. 2, the application 32 acts on that query. Specifically, the query is sent to the database server 40 and the results are returned at step 220.

FIG. 5 shows the form of a web page 500, which can be presented to the user to display these results. As in the web page 300 shown in FIG. 3, the web page 500 includes a text box 502, which, in this case, shows the user's selected query. In particular, it will be noted that the text box 502 contains text that resolves the ambiguity in the keyword shown in the text box 402 in FIG. 2, and more precisely (possibly uniquely) identifies the query selected by the user.

Thus, whereas the user had entered the keyword “churn” in the text box 302 of FIG. 3, and this was shown in the text box 402 of FIG. 4, the text box 502 of FIG. 5 contains the text “count by ChurnProbability”.

The web page 500 also presents the query results in the form of a table 504, as requested by the user. Thus the table 504 includes a first column 506, which lists various ranges for the estimated probability that a given user will churn, and a second column 508, which indicates the number of customers whose estimated probability of churn lies within those ranges.

The user has thus been able to obtain the required information, without needing to know exactly how the data is stored in the database, and without needing to know anything about the formal query language which is used.

In one preferred embodiment, the user is able to refine a search, after receiving an initial list of possible queries matching initially entered keywords.

Thus, the user is able to type one or more additional keywords into the text box 502 of the web page 500 shown in FIG. 5, at step 222 of the procedure of FIG. 2. In that case, the procedure loops back to step 212. For example, in this illustrated embodiment, the user types in the additional keyword “calls”.

As described with reference to steps 212 and 214 above, these additional keywords are analysed, and applied to the possible queries, taking account of the fact that the user has already selected a query when step 218 was first reached. In this case, therefore, steps 212 and 214 produce a set of refined query matches, and these are presented to the user at step 216.

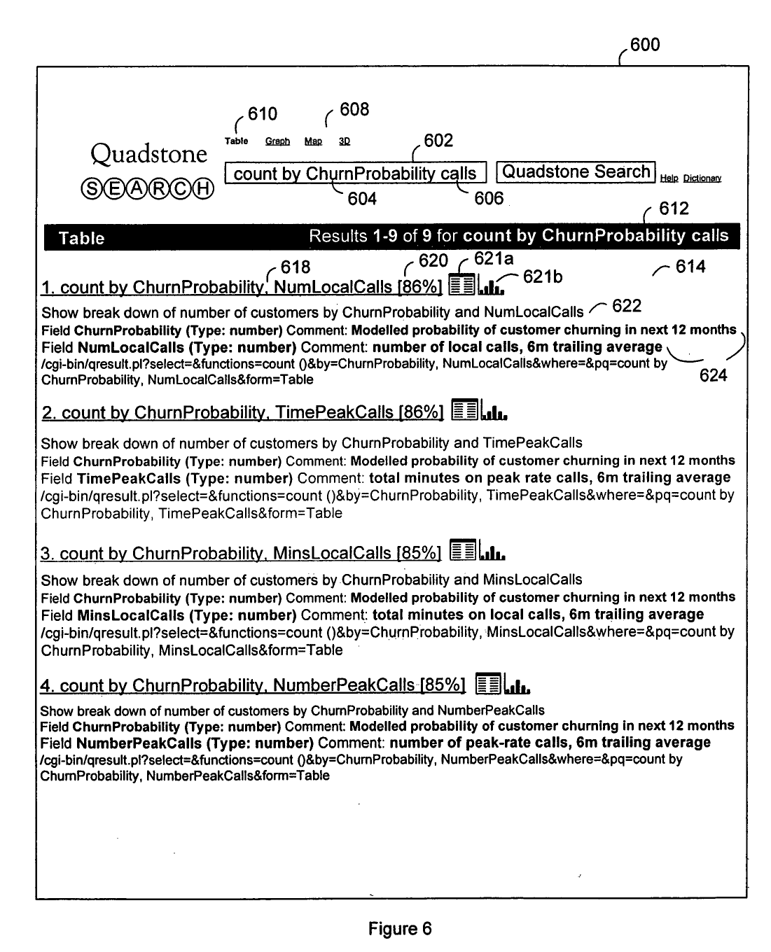

FIG. 6 shows the form of a web page 600, which can be presented to the user to display the results of the refined query. As in the web page 400 shown in FIG. 4, the web page 600 includes a text box 602, which, in this case, shows the user's previously selected query “count by ChurnProbability” 604, plus the additional keyword “calls” 606. As in FIG. 5, the user's previously selected query is shown by including keywords which are sufficient to define the selected query uniquely, although they are not necessarily the keywords entered by the user.

The web page 600 also indicates the various options 608, “Table”, “Graph”, “Map” and “3D”, with the “Table” option 610 being shown in a particular colour or typeface, to indicate that this has been chosen by the user. The web page 600 also indicates at 612 that in this case 9 results were found, and that all 9 are presented on this screen (although only 4 are visible in FIG. 6).

Finally, the web page 600 displays to the user a list 614 of all the possible queries that could be applied to the database that matched the query selected for refinement, plus the additional input keyword or keywords. As before, the list 614 is sorted by relevance, with the most relevant shown as item 1, and so on.

Further, each of the possible queries is then presented as an item in the list 614, shown in the same way. In this case, item “1” in the list is described in more detail. Thus, the presentation of the item shows first its “relevance” ranking 616, i.e. “1” in this case, and then a hyperlink 618, followed by its relevance score 620, in this case 86% and icons representing different possible display formats for the query. Thus, in the case of item “1” in the list, a first icon 621a indicates that the results can be presented as a table, while a second icon 621b indicates that the results can alternatively be presented as a bar graph.

The application 32 is able to create an English language description of each of the possible queries from the formal syntax of the query language and this English language description 622 is presented to the user, along with the formal version 624.

The underlying hyperlink 618 associated with each list entry is a link to the database server 40 and the formal query that can be understood by the database 45. If the user clicks on the hyperlink 618 for a selected query in the list, then, at step 218 in the procedure of FIG. 2, the application 32 acts on that query. Specifically, the query is sent to the database server 40 and the results are returned at step 220.

Allowing the user to refine a query in this way allows the user to execute the intended query more efficiently, since it avoids having to deal with the combinatorial effect of all possible queries when multiple keywords are supplied. For example, in the case of the example described above, the word “churn” (entered in the text box 302, as shown in the text box 402) was ambiguous, since it led to six possible queries, while the word “calls” (entered in the text box 502, as shown in the text box 602) was also ambiguous, since it led to nine possible queries. However, since the user was presented with the results in two stages, and the ambiguity in the first keyword was resolved before the second keyword was entered, he only needed to consider 6+9=15 possible queries in total to be able to select the intended query, rather than 6×9=54 possible queries. Clearly, the saving would be even greater when more than two keywords were entered, and/or when the entered keywords led to larger numbers of possible queries.

The query refinement mechanism has been described here with reference to a situation where the user is presented with a first list of possible queries in response to a first keyword, and the user then executes a query from the first list, and then enters a second keyword to refine the first query. However, the mechanism need not require that the first query should be executed, in order to allow the user to refine that query. For example, the results web page, shown in FIG. 4, could include an option allowing the user to select a query from the first list for refinement, without requiring that that query should be executed.

In a further embodiment of the invention, the system can operate to execute queries not only on data that currently exists in the database, but also on data that could be produced by modelling data in the database. For example, in response to the entered keyword “churn”, the system as described above returned possible queries relating to customers who have churned, and relating to a previously modelled probability of a customer churning in the next twelve months. However, a user might enter keywords indicating an interest in predictions of next month's churn (for example, such as “churn next month” or “predicted churn”), when this has not previously been modelled.

In that case, using known techniques, the system would then build a model, using parameters gleaned from metadata in the system (such as when information dates from, and whether it is available for forward modelling), generate a field containing predictions from the model, and make this available to queries, either in the context of a single query or a succession of queries. Thus the system could resolve a query such as “churn next month tenure” as “PredictedChurn by tenure”, even though there is no field PredictedChurn.

Although the mechanism has been described as being applied to a database it is clear that the technique could be applied to any set of structured data from which the set of all possible queries can be evaluated. Thus, the mechanism could also be applied to XML data and associated retrieval programs.

These are not the only possible embodiments of this invention. The method could also be used in situations where there is limited user input, such as where a user has access to a mobile phone with the possibility of SMS messages, i.e. messages of restricted length, possibly where the available keyboard has limited functionality. In this case the user might send an SMS message containing the word “bill” to a system. The set of potential queries would include data from accounting systems but also directory enquiries and address books. The reply from such a system could be “Do you want to know what your current bill amount is?” and “Do you want to know when your bill is payable?” and “Do you want to know the phone number of Bill Smith from your address book?” The query to be run might be initiated by pressing the relevant button on the phone, with the result of the query being delivered by SMS or as a voice call.

A more complex example might be using such an SMS interface as a way of keeping in touch with stock market information. Entering the keywords “average price manufacturing month” might offer queries such as “Display the average price of the FTSE manufacturing sector for the last month” or “Display the average price of all FTSE manufacturing sector companies for the last month” or “Display the average price of the FTSE manufacturing sector by month for the last year”. Thus, these keywords are giving rise to very different potential queries. If the user then added the additional keyword “year” as a refinement, the system might offer choices about displaying results for the past year, two years, ten years and so on.

An alternative embodiment of the invention might be found in a public information kiosk with a touch screen “soft” keyboard, such as found in railway stations. The user might enter “Bristol” and the set of queries returned might include “Do you want to know the next train to Bristol” and “Do you want to see a timetable for trains to Bristol” and “Do you want to know how much a ticket to Bristol costs” and so on. These options might be presented on a touch screen, with the user able to select the intended query by touching the screen at the appropriate position.

Still another embodiment of the invention combines the mechanism described above with a conventional text search. This can be achieved by sending the search string to one or more conventional search engines, as well as processing it as described above.

All of the results can then be assembled, and sorted and interleaved on the basis of relevance, using suitable conversion factors. In this way, the user could search both structured and unstructured data with a single set of words.

The present invention is suitable for highly complex cross-tabulation queries, includes match information gained from metadata and presents potential queries, not database items, in an ordered list with English explanations.

1. A method for providing a list of possible queries to be applied to one or more data storage systems, comprising:
receiving one or more keywords based on a user input;
comparing the received keywords with information based on metadata describing the data stored in the systems, in order to obtain matches between said received keywords and said information; and
based on said matches, generating a list of one or more possible queries, which could be applied to said one or more data storage systems.

2. A method as claimed in claim 1, further comprising returning to the user said list of one or more possible queries.

3. A method as claimed in claim 1, further comprising executing said queries, and returning to the user the results of executing said queries.

4. The method of claim 1, wherein said information comprises information representative of a set comprising all possible queries, which could be applied to said one or more data storage systems.

5. The method of claim 1, wherein said one or more possible queries are presented in a query language supported by said one or more data storage systems.

6. The method of claim 2, wherein said one or more possible queries are returned to the user in the form of links, such that, if the user selects a query from said link, the selected query is applied to one or more data storage systems.

7. The method of claim 6, wherein said one or more possible queries is displayed in a web browser window and a query can be selected by clicking on an associated hyperlink.

8. The method of claim 6, wherein said one or more possible queries is displayed as an SMS message on a portable communications device, and a query can be selected by pressing a button on said device.

9. The method of claim 6, wherein said one or more possible queries is displayed on a touch-sensitive screen, and a query can be selected by touching said screen at a relevant place.

10. The method of claim 2, comprising:
determining from the received keywords which of said possible queries is the most likely to be selected by the user; and
returning said list of one or more possible queries to the user with the most likely presented first in said list.

11. The method of claim 1, wherein one or more of the data storage systems is a collection of structured data and associated retrieval programs.

12. The method of claim 1, wherein one or more of the data storage systems is a collection of XML data and any associated retrieval programs.

13. The method of claim 1, wherein one or more of the data storage systems is a database.

14. The method of claim 1, comprising returning one or more possible queries, which could be applied to said one or more data storage systems, relating to data that could be produced by modelling data in the data storage systems.

15. The method of claim 1, wherein one or more of the data storage systems returns data generated by applying transformations to the underlying stored data.

16. The method of claim 1, wherein the one or more possible queries is such that, when applied to said one or more data storage systems, it would return tables of data.

17. The method of claim 1, wherein the one or more possible queries is such that, when applied to said one or more data storage systems, it would return tabular data containing aggregates or other quantities computed therefrom.

18. The method of claim 1, wherein the one or more possible queries is such that, when applied to said one or more data storage systems, it would return individual records.

19. The method of claim 1, wherein the one or more possible queries is such that, when applied to said one or more data storage systems, it would return graphs or maps.

20. The method of claim 1, wherein the one or more possible queries is such that, when applied to said one or more data storage systems, it would return visualisations of stored data.

21. The method of claim 1, wherein the or each query in the list of possible queries is presented with associated descriptive text.

22. The method of claim 1, further comprising:
receiving a user input, identifying one of said queries, from said list of possible queries, as a basis for refinement;
receiving one or more additional keywords, based on a user input;
comparing the received additional keywords with information based on the identified query and on said metadata describing the data stored in the systems, in order to obtain matches between said received additional keywords and said information; and
based on said matches, returning to the user a further list of one or more possible queries, which could be applied to said one or more information storage systems.

23. The method of claim 22, wherein said list of one or more possible queries is displayed in a web browser window and a query can be identified as a basis for refinement based on a user clicking on an associated hyperlink.

24. The method of claim 22, wherein said list of one or more possible queries is displayed as an SMS message on a portable communications device, and a query can be identified as a basis for refinement based on a user pressing a button on said device.

25. The method of claim 22, wherein said list of one or more possible queries is displayed on a touch-sensitive screen, and a query can be identified as a basis for refinement based on a user touching said screen at a relevant place.

26. The method of claim 1, comprising receiving the one or more keywords based on a user via voice recognition.

27. The method of claim 1, comprising receiving a user input, selecting a query from said list of one or more possible queries, by voice recognition.

28. The method of claim 1, wherein the or each query in said list of one or more possible queries comprises a query against structured data in said one or more data storage systems.

29. A computer system, comprising one or more data storage systems, for providing a list of possible queries to be applied to said one or more data storage systems,
wherein the system is adapted to:
receive one or more keywords based on a user input;
compare the received keywords with information based on metadata describing the data stored in the systems, in order to obtain matches between said received keywords and said information; and
based on said matches, return to the user a list of one or more possible queries, which could be applied to said one or more data storage systems.

30. A computer software product, comprising computer readable code, for performing a method for providing a list of possible queries to be applied to one or more data storage systems, comprising:
receiving one or more keywords based on a user input;
comparing the received keywords with information based on metadata describing the data stored in the systems, in order to obtain matches between said received keywords and said information; and
based on said matches, returning to the user a list of one or more possible queries, which could be applied to said one or more data storage systems.

31. A method for providing a list of possible queries to be applied to one or more data storage systems, comprising:
defining a set of structured data;
receiving one or more keywords based on a user input;
comparing the received keywords with information based on metadata describing said structured data, in order to obtain matches between said received keywords and said information; and
based on said matches, generating a list of one or more possible queries, which could be applied to said structured data.
